(19) United States
(12) Patent Application Publication
(10) Pub. No.: US 2021/0370743 A1
(43) Pub. Date: Dec. 2, 2021

(54) MICROWAVE HEAT CONVERTER AND SYSTEMS

(71) Applicant: R S Young, JR., Galveston, TX (US)

(72) Inventor: R S Young, JR., Galveston, TX (US)

(21) Appl. No.: 16/883,283

(22) Filed: May 26, 2020

(51) Int. Cl. B60H 1/00; H05B 6/70; H05B 6/78; H05B 6/80; F25B 15/00; B60H 1/22

(52) U.S. Cl. CPC B60H 1/00278; H05B 6/707; H05B 6/784; B60H 1/22; F25B 15/00; B60H 1/00392; H05B 6/804

(57) ABSTRACT

A microwave heat converter includes a cylindrical waveguide cavity, a non-conductive conduit, and a microwave waveguide. The non-conductive conduit is arranged to carry liquid flowing through a central area of the cylindrical waveguide cavity. The microwave waveguide is configured to deliver microwave power along the cylindrical waveguide cavity in a TE(1,1) mode to heat the liquid. The heat converter may be used in various systems such as heaters, combi boilers, and absorption refrigeration systems.

### FIELD OF THE INVENTION

This invention relates to heat conversion systems including heaters, HVAC, and other systems that employ heat exchangers.

### BACKGROUND

Natural gas is a common energy source for providing heat. For example, many common heating systems such as hot water heaters, HVAC, and even absorption refrigeration systems often use natural gas due to its common availability and low price. However, while natural gas is more carbon efficient than most other fossil fuels, it is less carbon efficient than alternative energy sources such as wind, solar, and nuclear.

Resistive heating elements are often used to heat water with an electrical energy source. For example, some home water heater systems, and heating systems for electric car batteries often employ resistive heating elements. However, the process of resistive heating is often slow or requires large amounts of current to heat water quickly. There is a need for improved methods of converting electrical energy to heat for various applications.

### SUMMARY

A microwave heat converter includes a cylindrical waveguide cavity, a non-conductive conduit, and a microwave waveguide. The non-conductive conduit is arranged to carry liquid flowing through a central area of the cylindrical waveguide cavity. The microwave waveguide is configured to deliver microwave power along the cylindrical waveguide cavity in a TE(1,1) mode to heat the liquid.

In some embodiments, the microwave waveguide is adapted to carry the microwave power in a TE(1,0) mode and is coupled to the cylindrical waveguide cavity in a manner adapted to convert the microwave power to propagate along the cylindrical waveguide cavity in the TE(1,1) mode. The microwave waveguide may be a rectangular waveguide coupled to the cylindrical waveguide cavity at an outer wall port of the cylindrical waveguide cavity having a first long dimension oriented in the longitudinal direction with respect to the cylindrical waveguide cavity and a second short dimension oriented perpendicularly to the long dimension.

In some embodiments, the cylindrical waveguide cavity has a radius of equal to or less than approximately 1.2 A and the rectangular microwave waveguide has a first long dimension of approximately A and a second short dimension of approximately 0.5 A, where A is the half-wavelength of the microwave power frequency. Preferably, the cylindrical waveguide cavity has a length in the longitudinal direction of at least 4 A.

In some embodiments, the cylindrical waveguide cavity further comprises two pressure-sealed ports through which the non-conductive conduit enters and leaves the cylindrical waveguide cavity, the two ports positioned centrally at longitudinal end caps of the cylindrical waveguide cavity. In some embodiments, the non-conductive conduit may include a polyethylene vinyl chloride (PVC) pipe, pyrex pipe, a glass pipe, or a plastic pipe.

The heat converter may be used in various systems such as heaters, combi boilers, and absorption refrigeration systems.

### BRIEF DESCRIPTION OF DRAWINGS

FIG. 1 is a perspective wireframe diagram view of a microwave heat converter according to an example embodiment.

FIG. 2 is a diagram showing an example heating system 200 employing a microwave heat converter 100 like that of FIG. 1.

FIG. 3 is a diagram showing an example combi boiler system 300 employing microwave heat converters similar to that of FIG. 1.

FIG. 4 is a diagram showing an example absorption refrigeration system 400 employing a microwave heat converter like that of FIG. 1.

FIG. 5 is a perspective cutaway diagram of a cylindrical waveguide cavity according to another embodiment.

### DETAILED DESCRIPTION OF EXAMPLE EMBODIMENTS

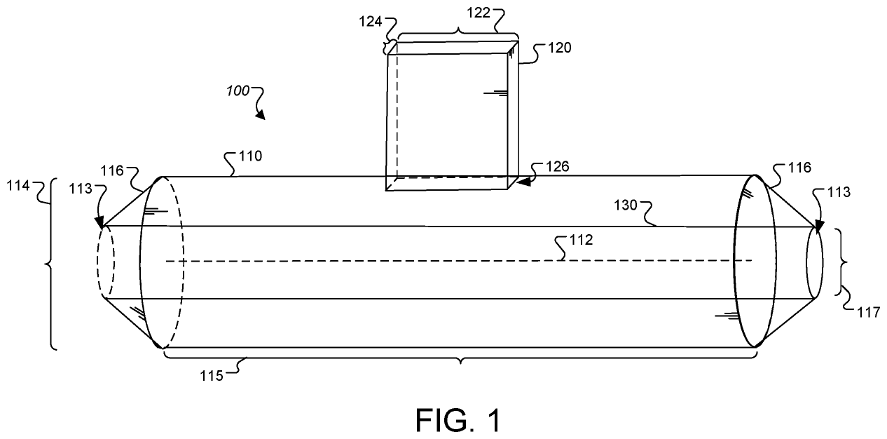

FIG. 1 is a perspective wireframe diagram view of a microwave heat converter 100 according to an example embodiment. Microwave heat converter 100 generally includes a cylindrical waveguide cavity 110, a rectangular microwave waveguide 120, and a non-conductive conduit 130. Cylindrical waveguide cavity 110 is provided to contain microwave radiation and direct it to heat liquid carried through non-conductive conduit 130. Microwave power is supplied with a microwave source (not shown separately), such as a magnetron, and directed into rectangular microwave waveguide 120. Rectangular microwave waveguide is configured to deliver microwave power along the cylindrical waveguide cavity in a TE(1,1) mode to heat the liquid.

Cylindrical waveguide cavity 110 is constructed of a suitable conductive metal known for use in microwave waveguides, such as brass, copper, silver, aluminum, or alloys thereof, for example. The interior surface may be plated for improved conductivity. In this embodiment, cylindrical waveguide cavity 110 includes two pressure-sealed ports 113 through which non-conductive conduit 130 enters and leaves the cylindrical waveguide cavity. The two ports 113 are positioned centrally at longitudinal end caps 116 of the cylindrical waveguide cavity, at opposing ends of cavity 110's longitudinal axis 112. End caps 116, in this embodiment, are generally conical in shape and constructed from a similar material to cylindrical waveguide cavity 110, but other embodiments may include other shapes such has a flat configuration or an S-curve configuration which transitions smoothly from the cylinder walls of cylindrical waveguide cavity 110 to the opening of ports 113. Preferably, cylindrical waveguide cavity 110 is constructed to prevent RF leakage as much as possible, given the need for ports 113 though which non-conductive conduit 130 passes. Some embodiments may have less restrictive RF leakage requirements than others.

In this embodiment, rectangular microwave waveguide 120 is a rectangular waveguide constructed of similar material to cylindrical waveguide cavity 110. Rectangular microwave waveguide 120 is adapted to carry the microwave power from the microwave source in a TE(1,0) mode, and is coupled to cylindrical waveguide cavity 110 in a manner adapted to convert the microwave power to propagate along cylindrical waveguide cavity 110 in the TE(1,1) mode. Such coupling is achieved in this embodiment with orientation of rectangular microwave waveguide 120 as it connects to cylindrical waveguide cavity 110. As depicted, rectangular microwave waveguide is coupled to the cylindrical waveguide cavity at an outer wall port 126 of cylindrical waveguide cavity 110. Port 126 and rectangular microwave waveguide 120 have a first long dimension 122 oriented in the longitudinal direction with respect to the cylindrical waveguide cavity and a second short dimension 124 oriented perpendicularly to the long dimension. This alignment positions the TE(1,0) primary rectangular power mode parallel to the TE(1,1) primary cylindrical power mode, allowing microwave power to move unimpaired into cylindrical waveguide cavity 110 for a transition to the TE(1,1) mode. Rectangular microwave waveguide 120 may be welded or soldered directly to the edges of outer wall port 126, or may be attached with a waveguide coupler. For example, a waveguide coupler may be employed to enhance impedance matching. Rectangular microwave waveguide 120 may include bends, turns, or joints other than that depicted as long as the coupling and transmission mode are not affected, depending on the application and the desired dimensions and shape of the overall system housing microwave heat converter 100.

In order to carry and convert the microwave power in the modes described, cylindrical waveguide cavity 110 and rectangular microwave waveguide 120 have size characteristics relative to the wavelength of microwave power employed. The size characteristics may be expressed in terms of the half-wavelength of the microwave power, which will referred to as “A”. For example, many common industrial microwave sources have a frequency of 2.45 GHz, which provides a wavelength of 12.2 cm and a have wavelength A of 6.1 cm. In a preferred embodiment, cylindrical waveguide cavity 110 has a diameter of approximately 1.2 A. Rectangular microwave waveguide 120 has a first long dimension 122 of approximately A and a second short dimension 124 of approximately 0.5 A. These dimensions may vary by a few percentage points to account for the frequency variation of microwave sources, for example. These dimensions result from waveguide equations using the cutoff wavelength (upper bound) of the waveguides necessary to provide the desired modes of TE(1,0) for the rectangular microwave waveguide and TE(1,1) for the cylindrical waveguide cavity. While other modes are possible in some embodiments, employing the TE(1,1) mode inside cylindrical waveguide cavity 110 is done to provide efficient RF power absorption to the liquid carried in non-conductive conduit 130.

As depicted in FIG. 1, rectangular microwave waveguide 120 is coupled to cylindrical waveguide cavity 110 at its center to allow propagation in both directions. To further allow for efficient power usage, the cylindrical waveguide cavity should have enough length to allow a large percentage of the power to be absorbed by the liquid. In one embodiment, a full wavelength, 2 A, in each direction for a total length of cylindrical waveguide cavity 110 in the longitudinal direction of at least 4 A. In other embodiments, a longer cylindrical waveguide cavity may be used to provide for higher total power absorption for each flow-through pass of the working fluid through non-conductive conduit 130. For example, a length of 6 A, 8 A, 10 A, or 12 A may be used. In some embodiments, multiple microwave waveguides may be used, coupled to the cylindrical waveguide cavity at intervals of 2 A.

Non-conductive conduit 130 is constructed of a suitable non-conductive material to allow RF power to penetrate and heat the fluid carried inside. For example, non-conductive conduit 130 may be constructed of polyethylene vinyl chloride (PVC), pyrex, or other glass or plastic material. Non-conducting conduit 130 is preferably sized to allow for RF power to penetrate to all of the fluid volume within the conduit to provide for efficient heating. For example, if the working fluid employed is water, 2.45 GHz microwaves penetrate in water to about 1 centimeter, and so the non-conductive conduit carrying the working fluid should have an inner diameter greater than 2 cm (0.79 inches), or >¾ inch. Other working fluids may be employed with other dielectric properties leading to a different absorption depth, for which the size may be adjusted. While in this embodiment, non-conductive conduit 130 is cylindrical and extends along the center of cylindrical waveguide cavity 110 in a co-axial arrangement, this is not limiting, and other embodiments may employ other shapes for non-conductive conduit 130. For example, a helical or coiled non-conductive conduit may be employed, providing for more volume of working fluid within the absorption depth, and therefore greater RF power absorbed as the working fluid flows through the central area of cylindrical waveguide cavity 110. As another example, conduit much larger than 2 cm may be employed, with a spacer included centrally in the conduit to displace the working fluid such that it only flows in the outer centimeter of volume.

In various embodiments, a microwave heat converter is employed in heating systems such as heaters, combi boilers, and absorption refrigeration systems. Any system that employs a liquid moving through a heat transfer system may possibly benefit from the techniques herein. While the microwave frequency used can vary in different applications, generally the a frequency is used from the industrial, scientific, and medical (ISM) frequency bands set aside for unlicensed purposes such as 2.45 GHz. Typically the microwave source used is a magnetron in a known configuration supplied with a high-voltage power source coupled through a high-voltage capacitor. Other suitable microwave sources may be used. The amount of microwave power used is selected based on the heating requirements, but may range from under 1000 watts for smaller systems to several thousand watts for larger systems. A single cavity magnetron may be used, or multiple cavity magnetrons arranged in series.

Various working fluids may be used for the liquid. For example, absorption refrigeration systems will typically employ a solution of water and lithium bromide or other suitable salt solution known in the industry. For combi boilers, a working fluid of water treated with various chemicals to prevent deposits is used. For heating systems in cold environments, a working fluid of water and antifreeze of any suitable type may be used. A pyrex or plexiglass seal may be used between the rectangular microwave waveguide and cylindrical waveguide cavity 110 to seal cavity 110 so that it can serve as a backup pressure vessel in the event that non-conductive conduit 130 is broken or leaks. The space between non-conductive conduit 130 and the cylindrical waveguide cavity 110 may be filled with a poured or machined polyethylene, polystyrene, or a suitable epoxy compound which is nearly as transparent to microwaves as air. Filling the space between the inner tube and the cylindrical cavity provides the converter with enhanced mechanical strength, shock mounting for the inner tube, and additional leak protection.

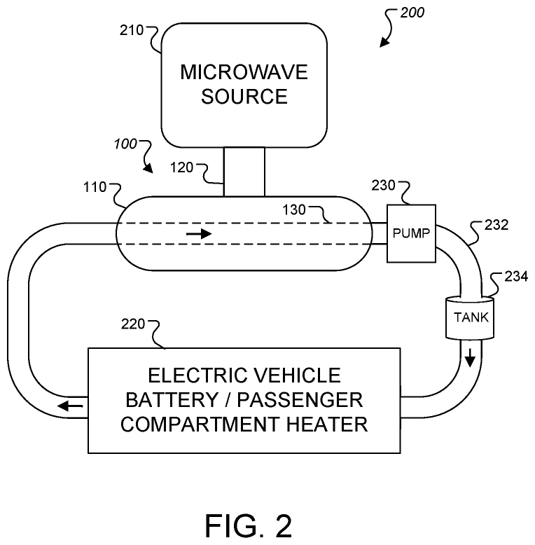

FIG. 2 is a diagram showing an example heating system 200 employing a microwave heat converter 100 like that of FIG. 1. The depicted heating system 200 is able to deploy electric power to provide heat for electric vehicle batteries in a manner more efficient than using resistive heating elements. Heating system 200 includes a microwave source 210 coupled to rectangular microwave waveguide 120. The microwave power from microwave source 210 is converted to heat a working fluid in non-conductive conduit 130 as described above. A fluid pump 230 is coupled to fluid conduits 232 to circulate the working fluid through an electric vehicle battery and/or passenger compartment heater 220. The arrows depict the direction of working fluid flow. A reservoir or tank 234 may be employed to store the working fluid. Generally the fluid conduits 232 and tank 234 should be constructed to withstand pressure and corrosion, but any suitable materials may be used for these, including both plastics and metals.

In this embodiment, the working fluid is a combination of ethylene glycol (antifreeze) with dielectric constant of approximately 37 and water with dielectric constant of −80. Using a 50/50 blend of antifreeze and water provides working fluid of approximately 59 dielectric constant and microwave power absorption approximately 74% that of water.

Microwave source 210 is preferably constructed with one or two cavity magnetrons with an output at 2.45 GHz. Thermostats may be used to measure working fluid temperature at the fluid input and output of microwave heat converter 100, and at the vehicle batteries, for feedback control of the heating process. Generally the microwave source may be supplied with power from the vehicle batteries using a high voltage converter, and an external power connection may be employed to provide ability to warm batteries with the vehicle parked, which may be independent of or in parallel with the vehicle charging circuitry. Control of electric vehicle battery heaters is known in the art and will not be further described.

The electric vehicle battery/passenger compartment heater 220 will vary in construction depending on the particular battery technology employed in the vehicle. Typically it will include multiple radiator or heat coupling structures interspersed with the vehicle batteries to evenly couple heat from the working fluid to the batteries. Passenger compartment heating, when used, includes a radiator through which air is blown and then ducted into the passenger compartment. In operation, microwave source 210 and pump 230 are controlled to heat and transport the working fluid to electric vehicle battery/passenger compartment heater 220 under control of the vehicle system controller, or a dedicated microcontroller.

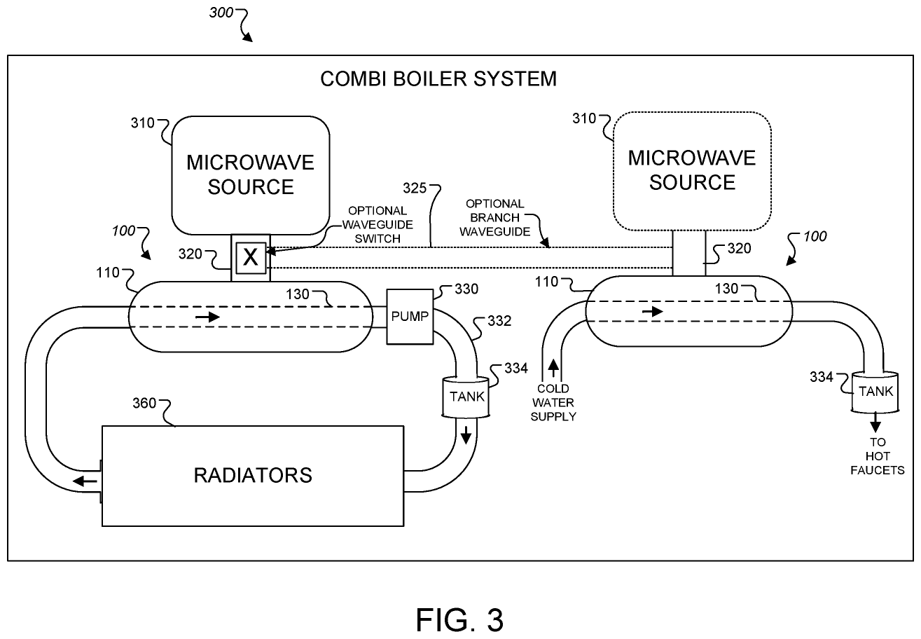

FIG. 3 is a diagram showing an example combi boiler system 300 employing microwave heat converters 100 similar to that of FIG. 1. Combi boiler system 300 provides environmental heat with a first microwave heat converter 100 through one or more radiators 360, and also provides hot water for plumbing with a second microwave heat converter 100. FIG. 3 depicts two options for the design of a combi boiler system 300, one with a single microwave source 310 supplying both sub-systems of combi boiler system 300, and the other with two separate microwave sources 310, one supplying the environmental heat subsystem depicted on the left of the drawing, and the other supplying the hot water supply subsystem depicted on the right.

Referring to the first optional design which employs both microwave sources, first microwave source 310 provides heating for the environmental heat subsystem. First microwave source 310 feeds microwave power through a first rectangular microwave waveguide 320 into cylindrical waveguide cavity 110 in which the fluid is heated in non-conductive conduit 330 as described with respect to FIG. 1. The heated working fluid is pumped with pump 330 to pass through conduits 332 to radiators 360 which are positioned in the area to be heated. A tank 334 may be used to store heated fluid to improve availability. Cooled working fluid returned to the input of cylindrical waveguide cavity 110.

In the hot water supply subsystem of the first optional design, a second microwave source 310 feeds microwave power through a second rectangular microwave waveguide 320 and into a second cylindrical waveguide cavity 110. Cold water from the plumbing supply is fed to non-conductive fluid conduit 130 and heated with microwave power as discussed herein. The heated water is supplied to hot water plumbing for use. A tank 334 may be used to improve availability of hot water.

The second optional design does not use the second microwave source depicted in dotted lines. Instead, the first microwave source 310 is used to provide microwave power for both subsystems. First microwave source 310 feeds microwave power to a first rectangular microwave waveguide 320. The second optional design includes a waveguide switch in first rectangular microwave waveguide 320 which is controlled to direct the microwave power either down to first cylindrical waveguide cavity 110 or into an optional branch waveguide 325. In both designs, temperature sensors are used at the ports of microwave heat converter 100 to provide temperature data for use in controlling both the microwave sources and the pumps. The hot water supply subsystem may also include a flow sensor.

While the example of FIG. 3 employs two separate microwave heat converters, in other embodiments a single microwave heat converter may be used, along with a heat exchanger for providing heat to the plumbing system, as employed commonly with combi boilers.

As can be understood, other embodiments may provide a simple hot water heating system such as a tankless water heater, or a tank water heater, employing the design depicted for the hot water supply subsystem of FIG. 3.

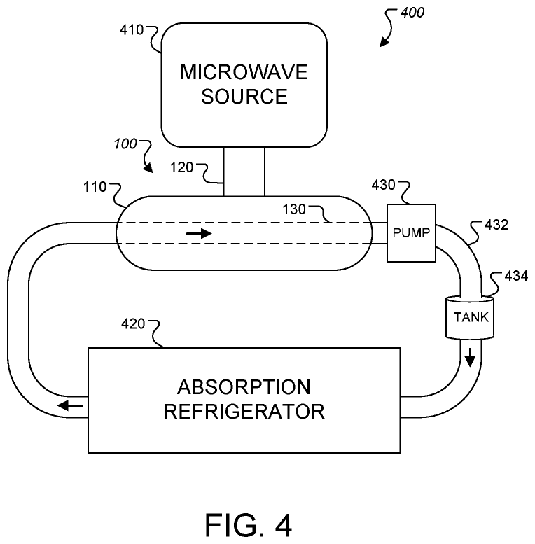

FIG. 4 is a diagram showing an example absorption refrigeration system 400 employing a microwave heat converter 100 like that of FIG. 1. The depicted absorption refrigeration system 400 is able to deploy electric power to provide air conditioned cooling in a manner more efficient than using resistive heating elements. Absorption refrigeration system 400 includes a microwave source 410 coupled to rectangular microwave waveguide 120. The microwave power from microwave source 410 is converted to heat a working fluid in non-conductive conduit 130 as described above. A fluid pump 430 is coupled to fluid conduits 432 to circulate the working fluid through absorption refrigerator 420. The arrows depict the direction of working fluid flow. A reservoir or tank 434 may be employed to store the working fluid. Generally the fluid conduits 432 and tank 434 should be constructed to withstand pressure and corrosion, but any suitable materials may be used for these, including both plastics and metals. The working fluid employed is typically a solution of water and lithium bromide (LiBr) or other suitable salt solution known in the art.

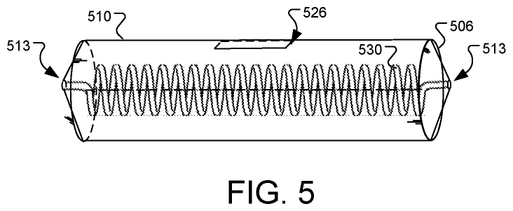

FIG. 5 is a perspective cutaway diagram of a cylindrical waveguide cavity 510 according to another embodiment. In this embodiment, cylindrical waveguide cavity 510 includes a non-conductive conduit 530 in a helical shape. Non-conductive conduit 530 carries fluid along a central portion of cylindrical waveguide cavity 510 from one of pressure-sealed ports 513 to the other. In use, microwave power is introduced through outer wall port 526 in the same manner as described with respect to the cylindrical waveguide cavity of FIG. 1 to heat the fluid as is passes through non-conductive conduit 530. The helical shape of non-conductive conduit 530 provides for increased working fluid volume that is reachable by RF power.

The above described preferred embodiments are intended to illustrate the principles of the invention, but not to limit the scope of the invention. Various other embodiments and modifications to these preferred embodiments may be made by those skilled in the art without departing from the scope of the present invention.

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

1. An apparatus comprising:
a cylindrical waveguide cavity;
a non-conductive conduit arranged to carry liquid flowing through a central area of the cylindrical waveguide cavity; and
a microwave waveguide configured to deliver microwave power along the cylindrical waveguide cavity in a TE(1,1) mode to heat the liquid.

2. The apparatus of claim 1, wherein the microwave waveguide is adapted to carry the microwave power in a TE(1,0) mode and is coupled to the cylindrical waveguide cavity in a manner adapted to convert the microwave power to propagate along the cylindrical waveguide cavity in the TE(1,1) mode.

3. The apparatus of claim 2, wherein the microwave waveguide is a rectangular waveguide coupled to the cylindrical waveguide cavity at an outer wall port of the cylindrical waveguide cavity having a first long dimension oriented in the longitudinal direction with respect to the cylindrical waveguide cavity and a second short dimension oriented perpendicularly to the long dimension.

4. The apparatus of claim 3, wherein the cylindrical waveguide cavity has a radius of equal to or less than approximately 1.2 A and the rectangular microwave waveguide has a first long dimension of approximately A and a second short dimension of approximately 0.5 A, where A is the half-wavelength of the microwave power frequency.

5. The apparatus of claim 4, wherein the cylindrical waveguide cavity has a length in the longitudinal direction of at least 4 A.

6. The apparatus of claim 4, wherein the microwave power frequency is approximately 2.45 Ghz.

7. The apparatus of claim 1, wherein the cylindrical waveguide cavity further comprises two pressure-sealed ports through which the non-conductive conduit enters and leaves the cylindrical waveguide cavity, the two ports positioned centrally at longitudinal end caps of the cylindrical waveguide cavity.

8. The apparatus of claim 1, wherein the non-conductive conduit is one of the group consisting of a polyethylene vinyl chloride (PVC) pipe, pyrex pipe, a glass pipe, and a plastic pipe.

9. The apparatus of claim 1, further comprising an electric vehicle battery system or an electric vehicle passenger heating system coupled to receive the heated liquid from the non-conductive conduit.

10. The apparatus of claim 1, wherein the apparatus further comprises a combi boiler system coupled to receive the heated liquid from the non-conductive conduit.

11. The apparatus of claim 1, further comprising an absorption refrigeration system coupled to receive the heated liquid from the non-conductive conduit.

12. The apparatus of claim 1, further comprising the liquid, wherein the liquid is a mixture of lithium bromide (LiBr) salts and water.

13. The apparatus of claim 1, further comprising a heat transfer system thermally coupled to the non-conductive conduit outside of the cylindrical waveguide cavity to absorb heat from the liquid.

14. A method comprising:
moving a liquid along a central area of a cylindrical waveguide cavity;
delivering microwave power to the cylindrical waveguide cavity such that the microwave power propagates longitudinally along the cylindrical waveguide cavity in a TE(1,1) mode and heats the liquid;
moving the heated liquid from the cylindrical waveguide cavity to a heat transfer system; and
transferring heat out of the heated liquid at the heat transfer system.

15. The method of claim 14, further comprising delivering the microwave power to the cylindrical waveguide cavity with a rectangular microwave waveguide in which the microwave power propagates in a TE(1,0) mode, wherein the rectangular microwave waveguide is coupled to the cylindrical waveguide cavity such that the microwave power is converted to propagate in the TE(1,1) mode in the cylindrical waveguide cavity.

16. The method of claim 15, wherein the rectangular microwave waveguide is coupled to the cylindrical waveguide cavity at an outer wall port of the cylindrical waveguide cavity having a first long dimension oriented in the longitudinal direction with respect to the cylindrical waveguide cavity and a second short dimension oriented perpendicularly to the long dimension of the cylindrical waveguide cavity.

17. The method of claim 14, wherein the liquid is moved along a central area of the cylindrical waveguide cavity in a non-conductive conduit.

18. The method of claim 14, wherein the heat transfer system is a heater for an electric vehicle battery system or passenger compartment heater system.

19. The method of claim 14, wherein the heat transfer system is an absorption refrigeration system.

20. The method of claim 14, wherein the heat transfer system is a combi boiler system.
